(19) United States
(12) Patent Application Publication
(10) Pub. No.: US 2026/0214600 A1
(43) Pub. Date: Jul. 23, 2026

(54) FEATURE GROUPS FOR ON-DEMAND OPERATIONS

(71) Applicant: QUALCOMM Incorporated, San Diego, CA (US)

(72) Inventors: Hung Dinh LY, San Diego, CA (US); Jae Ho RYU, San Diego, CA (US); Heechoon LEE, San Diego, CA (US)

(21) Appl. No.: 19/394,863

(22) Filed: Nov. 19, 2025

Related U.S. Application Data
(60) Provisional application No. 63/746,819, filed on Jan. 17, 2025.

(51) Int. Cl. H04W 56/00

(52) U.S. Cl. CPC H04W 56/001

(57) ABSTRACT

Methods, systems, and devices for wireless communications are described. A user equipment (UE) may report capability information (e.g., regarding on demand or always-on synchronization signal block (SSB) transmissions). Such capability information may be reported in terms of a feature group supported by the UE. The feature group may indicate, among other examples, whether the UE supports on-demand or always-on SSBs, activation or deactivation of such SSBs via media access control (MAC) control elements (CEs) or radio resource control (RRC) signaling, and one or more additional elements (e.g., components). The UE may report a supported feature group indicating one or more specific components supported by the UE, a signaling granularity, etc. Each reported feature group (e.g., indicated by an index) may correspond to a set of one or more additional feature groups that the UE also supports (e.g., prerequisite feature groups that the UE supports).

### CROSS REFERENCE

The present Application for Patent claims priority to U.S. Provisional Patent Application No. 63/746,819 by Ly et al., entitled “FEATURE GROUPS FOR ON-DEMAND OPERATIONS,” filed Jan. 17, 2025, assigned to the assignee hereof and incorporated by reference in its entirety.

### FIELD OF TECHNOLOGY

The following relates to wireless communications, including feature groups for on-demand operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof and receiving a control message activating or deactivating on-demand SSB transmissions for the cell based on the capability information message.

A UE for wireless communications is described. The UE may include one or more memories storing processor executable code, and one or more processors coupled with the one or more memories. The one or more processors may individually or collectively be operable to execute the code to cause the UE to transmit a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof and receive a control message activating or deactivating on-demand SSB transmissions for the cell based on the capability information message.

Another UE for wireless communications is described. The UE may include means for transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof and means for receiving a control message activating or deactivating on-demand SSB transmissions for the cell based on the capability information message.

A non-transitory computer-readable medium storing code for wireless communications is described. The code may include instructions executable by one or more processors to transmit a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof and receive a control message activating or deactivating on-demand SSB transmissions for the cell based on the capability information message.

In some examples of the method, user equipment (UEs), and non-transitory computer-readable medium described herein, receiving the control message may include operations, features, means, or instructions for receiving a media access control (MAC) control element (CE), where the supported feature group includes an indication that the UE supports the activation or deactivation via the MAC-CE.

In some examples of the method, user equipment (UEs), and non-transitory computer-readable medium described herein, receiving the control message may include operations, features, means, or instructions for receiving a radio resource control (RRC) message, where the supported feature group includes an indication that the UE supports the activation or deactivation via the RRC message.

In some examples of the method, user equipment (UEs), and non-transitory computer-readable medium described herein, the supported feature group includes an indication that the UE supports activation or deactivation of the on-demand SSB transmissions, and the feature group support may be applied to a single set of one or more cells with periodic SSB transmissions or may be applied to single set of one or more cells without periodic SSB transmissions.

In some examples of the method, user equipment (UEs), and non-transitory computer-readable medium described herein, the supported feature group includes an indication that the UE supports carrier aggregation, and that the UE supports activation or deactivation of on-demand SSB transmissions in addition to the periodic SSB transmissions via a first set of one or more cells, and supports activation or deactivation of the on-demand SSB transmissions via a second set of one or more cells without periodic SSB transmissions that may be different from the first set of one or more cells.

In some examples of the method, user equipment (UEs), and non-transitory computer-readable medium described herein, the signaling granularity level includes a per device granularity, a per band granularity, a per band combination granularity, a feature set per component carrier granularity, a per frequency range granularity, a per carrier type granularity, a per component carrier per band per band combination, or any combination thereof.

In some examples of the method, user equipment (UEs), and non-transitory computer-readable medium described herein, the supported feature group includes an indication that the UE supports layer three measurements for deployment where one or more neighbor cells support the periodic SSB transmissions or the on-demand SSB transmissions.

In some examples of the method, user equipment (UEs), and non-transitory computer-readable medium described herein, the supported feature group corresponds to one or more prerequisite feature groups that may be also supported by the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports feature groups for on-demand operations in accordance with one or more aspects of the present disclosure.

FIG. 2 shows an example of a timeline that supports feature groups for on-demand operations in accordance with one or more aspects of the present disclosure.

FIG. 3 shows an example of a timeline that supports feature groups for on-demand operations in accordance with one or more aspects of the present disclosure.

FIG. 4 shows an example of a timeline that supports feature groups for on-demand operations in accordance with one or more aspects of the present disclosure.

FIG. 5 shows an example of a timeline that supports feature groups for on-demand operations in accordance with one or more aspects of the present disclosure.

FIG. 6 shows an example of a timeline that supports feature groups for on-demand operations in accordance with one or more aspects of the present disclosure.

FIG. 7 shows an example of a process flow that supports feature groups for on-demand operations in accordance with one or more aspects of the present disclosure.

FIGS. 8 and 9 show block diagrams of devices that support feature groups for on-demand operations in accordance with one or more aspects of the present disclosure.

FIG. 10 shows a block diagram of a communications manager that supports feature groups for on-demand operations in accordance with one or more aspects of the present disclosure.

FIG. 11 shows a diagram of a system including a device that supports feature groups for on-demand operations in accordance with one or more aspects of the present disclosure.

FIG. 12 shows a flowchart illustrating methods that support feature groups for on-demand operations in accordance with one or more aspects of the present disclosure.

### DETAILED DESCRIPTION

In some examples, a UE may monitor for and receive signaling such as synchronization signal blocks (SSBs). SSBs may be transmitted periodically (e.g., which may be referred to as always-on SSB transmission), or may be transmitted upon request or demand (e.g., which may be referred to as no-always-on SSB, or on-demand SSB transmissions). Period or always-on SSB transmissions may be referred to as case 1, and on-demand SSB transmissions may be referred to as case 2. Case 1 or case 2 may be configured or applied to a specific cell or set of cells. Configuration of SSBs may be done via a set of parameters including a subframe number satisfying one or more conditions, a half frame index parameter, or a single activation or deactivation parameter. For example, SSBs may be configured in SSB bursts. In some cases, on-demand SSB transmissions may be configured or activated by a media access control (MAC) control element (CE), or via radio resource control (RRC) signaling. In some examples, on-demand SSB transmissions may be deactivated (e.g., for a cell such as a secondary cell (SCell) via MAC-CE or RRC signaling. Some user equipments (UEs) may be capable of SSB transmissions via case 1, case 2, or both. Some UEs may support MAC-CE activation or deactivation of SSB transmissions, or RRC signaling activation or deactivation of SSB transmissions (e.g., or both). However, if the network entity is not aware of which devices support which functionalities (e.g., case 1, case 2, activation or deactivation of case 1 or case 2 via RRC signaling or MAC-CE signaling), the network entity may not be able to effectively or efficiently configure the UE with SSB transmissions in case 1 or case 2. Additionally, some UEs may support some of the above-described functionalities in specific frequency resources, time resources, or a combination thereof (e.g., may support time domain resources for always-on SSB bursts as a subset of time domain locations of on-demand SSB bursts, among other examples).

According to techniques described herein, a UE may report capability information (e.g., regarding case 1, case 2, or both types of SSB transmissions). Such capability information may be reported in terms of a feature group supported by the UE. The feature group may indicate, among other examples, whether the UE supports case 1, case 2, and one or more additional elements (e.g., components). Such components may include an indication of whether the UE supports activation or deactivation of case 1 and/or case 2 via RRC signaling, MAC-CE signaling, or both, time or frequency resources or configurations for SSB transmissions, and a signaling granularity. In some examples, the UE may indicate the supported feature group that corresponds to an index value. The index value may correspond to a feature group indicating one or more specific components supported by the UE, a signaling granularity, etc. In some examples, each feature group (e.g., indicated by each index) may correspond to a set of one or more additional feature groups that the UE also supports (e.g., prerequisite feature groups that the UE supports in order for the indexed feature group to be supported by the UE).

Some feature groups (e.g., a first set of supported feature groups) may correspond to support of MAC-CE activation or deactivation of case 1, case 2, or both. Some feature groups (e.g., a second set of supported feature groups) may correspond to support of RRC signaling based indications for case 1, case 2, or both. Some feature groups may be defined such that the UE supports case 1, case 2, or both, via a single set of cells. Some feature groups may be defined such that the UE may report its ability to support CA configuration with a set of cells where the UE supports case 1 via a first subset of cells and supports case 2 via a second subset of cells. Some feature groups may indicate that the UE supports the indicated features according to a particular signaling granularity (e.g., per band combination, per UE, per FSPC, per component carrier (CC) per band per band combination, per frequency range, per carrier type (e.g., FR1 time division duplexing (TDD), FR1 frequency division duplexing (FDD), FR1 unlicensed, FR2, etc.), where carrier type is defined with respect to a target SCell, and where on-demand SSBs can be configured and activated). Some feature groups may be defined to report whether the UE can support layer 3 (L3) measurements for neighbor cells that have case 1 or case 2 configured for L3 measurements.

Aspects of the disclosure are initially described in the context of wireless communications systems. Aspects of the disclosure are further illustrated by and described with reference to timelines and wireless communications systems. Aspects of the disclosure are further illustrated by and described with reference to apparatus diagrams, system diagrams, and flowcharts that relate to feature groups for on-demand operations.

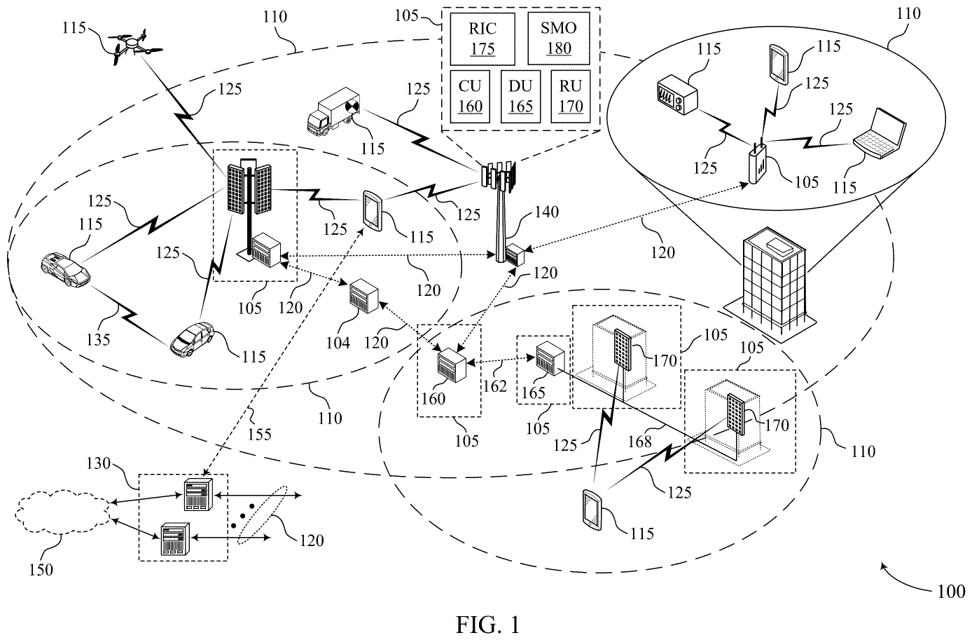

FIG. 1 shows an example of a wireless communications system 100 that supports feature groups for on-demand operations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support feature groups for on-demand operations as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a UE may report capability information (e.g., regarding case 1, case 2, or both types of SSB transmissions). Such capability information may be reported in terms of a feature group supported by the UE. The feature group may indicate, among other examples, whether the UE supports case 1, case 2, and one or more additional elements (e.g., components). Such components may include an indication of whether the UE supports activation or deactivation of case 1 and/or case 2 via RRC signaling, MAC-CE signaling, or both, time or frequency resources or configurations for SSB transmissions, and a signaling granularity. In some examples, the UE may indicate the supported feature group that corresponds to an index value. The index value may correspond to a feature group indicating one or more specific components supported by the UE, a signaling granularity, etc. In some examples, each feature group (e.g., indicated by each index) may correspond to a set of one or more additional feature groups that the UE also supports (e.g., prerequisite feature groups that the UE supports in order for the indexed feature group to be supported by the UE).

Some feature groups (e.g., a first set of supported feature groups) may correspond to support of MAC-CE activation or deactivation of case 1, case 2, or both. Some feature groups (e.g., a second set of supported feature groups) may correspond to support of RRC signaling based indications for case 1, case 2, or both. Some feature groups may be defined such that the UE supports case 1, case 2, or both, via a single set of cells. Some feature groups may be defined such that the UE may report its ability to support CA configuration with a set of cells where the UE supports case 1 via a first subset of cells and supports case 2 via a second subset of cells. Some feature groups may indicate that the UE supports the indicated features according to a particular signaling granularity (e.g., per band combination, per UE, per FSPC, per component carrier (CC) per band per band combination, per frequency range, per carrier type (e.g., FR1 time division duplexing (TDD), FR1 frequency division duplexing (FDD), FR1 unlicensed, FR2, etc.), where carrier type is defined with respect to a target SCell, and where on-demand SSBs can be configured and activated). Some feature groups may be defined to report whether the UE can support layer 3 (L3) measurements for neighbor cells that have case 1 or case 2 configured for L3 measurements.

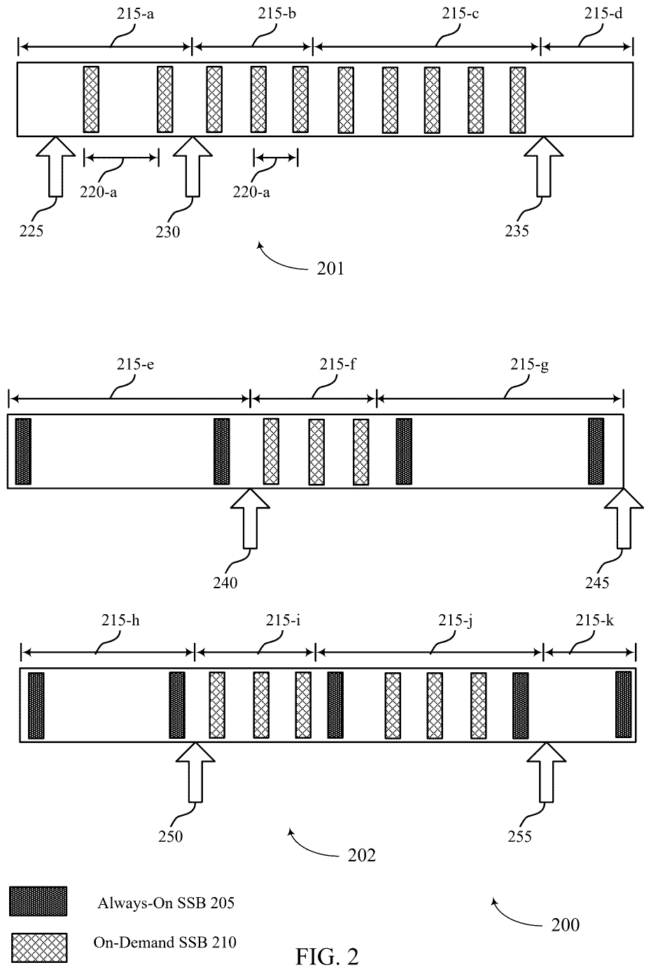

FIG. 2 shows an example of a timeline 200 that supports feature groups for on-demand operations in accordance with one or more aspects of the present disclosure.

Some wireless communications systems support on-demand SSB operation in Scells for connected mode UEs configured with CA as one of techniques to improve network energy savings. Such procedures may include signaling methods supporting on-demand SSB SCell operation for UEs in connected mode configured with CA, for both intra-/inter-band CA. This may include triggering methods such as selecting from UE uplink wake-up-signal using an existing signal/channel, cell on/off indication via backhaul, Scell activation/deactivation signaling). On-demand SSB transmission can be used by UE for at least SCell time/frequency synchronization, L1/L3 measurements and SCell activation, and is supported for FR1 and FR2 in non-shared spectrum.

There are at least two cases regarding how always-on (e.g., periodic) SSB is transmitted in the cell supporting on-demand SSB Scell operation as illustrated in FIG. 2. Regarding a UE assumption on SSB transmission on a cell supporting on-demand SSB SCell operation, the following cases are relevant. In some examples (e.g., which may be referred to as Case #1) no always-on SSBs may be supported on the cell. For example, as illustrated with reference to example 201, on-demand SSBs 210 may be transmitted by the cell. During time duration 215-a, an SCell may be deactivated. A MAC-CE 225 may indicate on-demand SSBs 210 with a periodicity 220-a (e.g., periodicity P1). During time duration 215-b, a transition to activation of the SCell may be performed. For example, the MAC-CE 230 may indicate on-demand SSB transmission with a periodicity 220-a (e.g., periodicity P2, where P2<P1). Based on the MAC-CE 230, the SCell may transition to activation. At the beginning of the time duration 215-c, SCell activation may be completed and the SCell may be activated for the duration of the time duration 215-c. The message 235 may include an SCell deactivation command, which may deactivate the SCell for the duration of the time duration 215-d.

In some examples (e.g., example 202, which may be referred to as Case #2), always-on SSB may be periodically transmitted on the cell. In some cases, always-on SSB and on-demand SSB are not cell-defining SSB if transmitted. During or at the beginning of the time duration 215-e, the SCell may be configured. always=on SSBs 205 maybe periodically transmitted. At the beginning of the time duration 215-f, the message 240 (e.g., a MAC-CE or an RRC message) may include an SCell activation command. During the time duration 215-f, the SCell may transition from deactivated to activated. On-demand SSBs 210 may be transmitted during the time duration 215-f. At the beginning of the time duration 215-g, the SCell may be activated, and the always-on SSBs 205 may be transmitted. The message 245 may include an SCell deactivation. During the time duration 215-h, the Scell may be deactivated. The message 250 may be a MAC-CE indicating on-demand SSB transmissions with a periodicity (e.g., of P1). The on-demand SSBs 210 may be transmitted accordingly during the time duration 215-i, which may be transmitted while the SCell is in transition. The SCell activation may be completed at the beginning of the time duration 215-j, during which always-on SSBs 205, on-demand SSBs 210, or both, may transmitted. The message 255 may include an SCell deactivation command, and the SCell may be deactivated for the time duration 215-k.

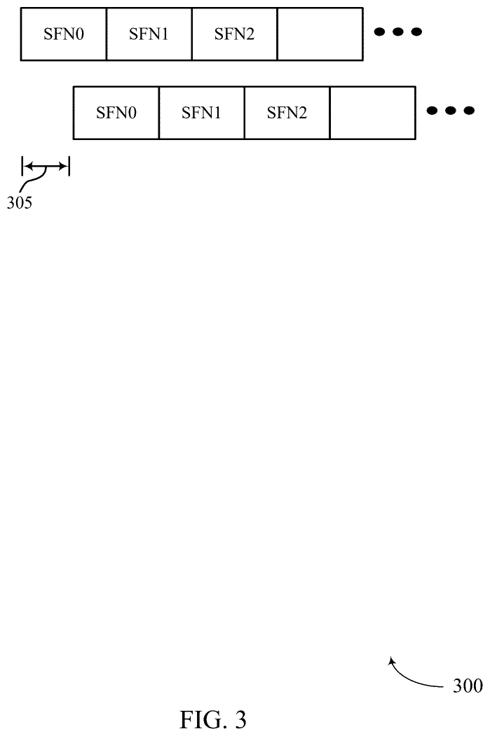

FIG. 3 shows an example of a timeline 300 that supports feature groups for on-demand operations in accordance with one or more aspects of the present disclosure. FIG. 3 may illustrate an example of a slot offset between the primary cell and Scell in unaligned CA configuration.

Some wireless communications systems may support time-domain configuration of on-demand SSB bursts. For time domain configuration of on-demand SSB bursts, SSB time domain positions of on-demand SSB burst are configured by gNB. Furthermore, the location(s) (e.g., SFN offset, half frame index) in the time domain of “possible” on-demand SSB burst and SSB position within the burst should be configured by the gNB. For a cell supporting on-demand SSB SCell operation, the system may support configuration of time domain location of on-demand SSB per on-demand SSB periodicity by RRC for both Case #1 and Case #2.

In some examples (e.g., Case #1, with no always-on SSB on the cell), time domain location of on demand SSB per on-demand SSB periodicity may be based on two parameters, where one parameter is to indicate SFN offset from a reference point and the other parameter is to indicate half frame index. The reference point is an SFN which satisfies (SFN index*10) modulo (OD-SSB periodicity)=0. If the SFN offset parameter is not configured, the UE assumes the SFN offset set to 0. If a half frame index parameter is not configured, the UE may assume that the half frame index set to 0. The value range of the SFN offset is 0 to 15 unless longer periodicity for on-demand SSB than 160 ms is introduced. The value range of half frame index is 0 or 1. In some examples (e.g., Case #2, where always-on SSB is periodically transmitted on the cell), down-selection may be performed for one of the following alternatives. Some examples (e.g., Alt A), may be the same as for Case #1. In some examples (e.g., Alt B), configuration may be based on a single parameter which is to indicate the time offset between always-on SSB and on-demand SSB (e.g., similar to ssb-TimeOffset).

In particular, techniques described herein may be related to the time domain configuration for on-demand SSB. An SFN offset (e.g., the offset 305, which may be referred to as a ca-SLotOffset) between Pcell and Scell may define is a slot offset (e.g., no more than 2.5 ms) between the primary cell (PCell/PSCell) and the SCell in inter-band CA deployments having unaligned frame boundary with slot alignment and partial SFN alignment as being illustrated in FIG. 2. The UE determines the time offset of the SCell as specified in one or more standards documents. The network configures at most a single non-zero offset duration in ms (independent on SCS) among CCs in the unaligned CA configuration. If the field is absent, the UE applies the value of 0. The slot offset value can only be changed with SCell release and add via parameter ca-SlotOffset in ServingCellConfig.

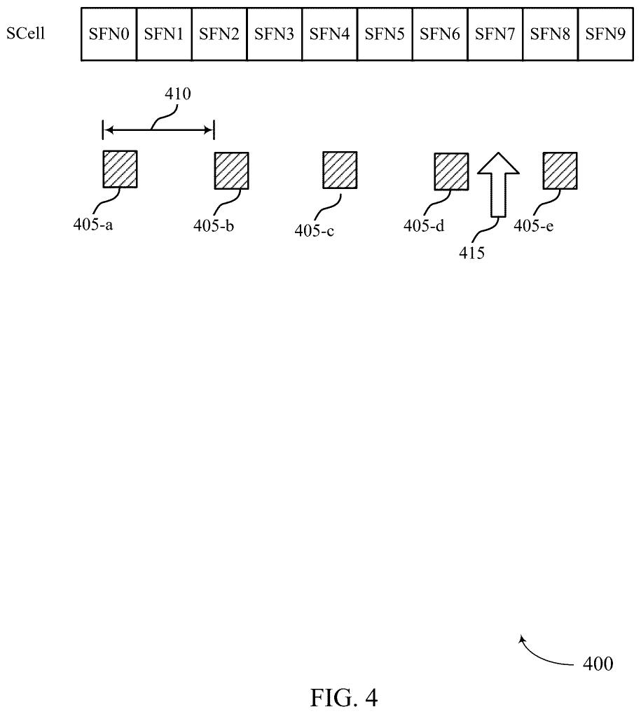

FIG. 4 shows an example of a timeline 400 that supports feature groups for on-demand operations in accordance with one or more aspects of the present disclosure. FIG. 4 may illustrate an example of periodic SSB bursts starting from SFN0 in the second half-frame.

An SFN offset and half-frame in which the SSB burst is located in Scell may be configured by a network entity (e.g., configured with SFN offset 0 and half-frame index 1). If not configured, default values for the SFN offset and half-frame index are assumed. In such examples, periodic SSB bursts may be scheduled starting from SFN0 in the second half of a frame.

For example, candidate SSB bursts 405 (e.g., the SSB burst 405-a, the SSB burst 405-b, the SSB burst 405-c, the SSB burst 405-d, and the SSB burst 405-e) may be configured with a periodicity 410 (e.g., 20 ms). The UE may assume that no SSB transmissions occurs in one or more SSBN bursts (e.g., the SSB burst 405-a, the SSB burst 405-b, the SSB burst 405-c, and the SSB burst 405-d). A message 415 (e.g., a MAC-CE) may indicate an on-demand SSB transmission (e.g., in a next SFN with an SFN offset 0 and half frame index 1). In SFN 8, the UE may assume that the SSB transmission will occur in the SSB burst 405-e.

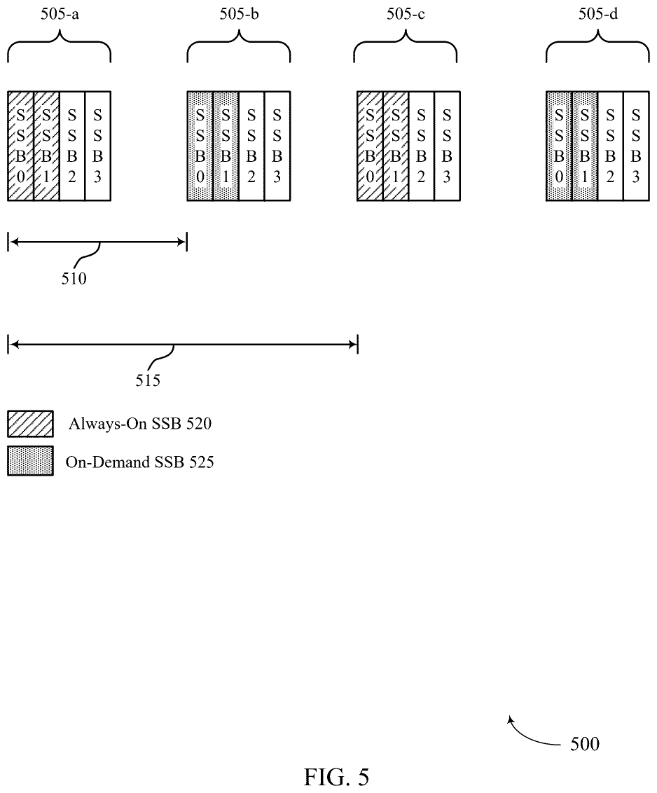

FIG. 5 shows an example of a timeline 500 that supports feature groups for on-demand operations in accordance with one or more aspects of the present disclosure. FIG. 5 may illustrate an example of a time-domain relationship between always-on SSB burst and on-demand SSB burst when both have the same frequency locations.

An SSB position in SSB bursts 505 (e.g., the SSB burst 505-a, the SSB burst 505-b, the SSB burst 505-c, and the SSB burst 505-d, etc.) may be used to indicate the actually transmitted SSBs in SSB burst. This information is used at least for the purpose of SSB-RO mapping for RACH in the SCell. For Case #2 scenarios, the time-domain configuration of on-demand SSB should be similar to the configuration defined for Case #1. Furthermore, at least for the deployment in which the frequency locations of the always-on SSB and the on-demand SSB are identical, the time domain locations of always-on SSB burst may be a subset of the time domain locations of on-demand SSB burst as illustrated in FIG. 5. For example, always on SSB bursts and on-demand SSB bursts may overlap fully (e.g., in SSB bursts 505). SSB bursts 505 may occur at a periodicity 510 (e.g., P1=20 ms). Always on SSBs 520 may occur in some SSBs (e.g., SSB0 and SSB1) of some SSB bursts (e.g., SSB burst 505-a and SSB burst 505-c, at a periodicity 515 (e.g., P0=40 ms)). On-demand SSBs 525 may occur in some SSBs (e.g., SSB0 and SSB 1) of some SSB bursts (e.g., SSB burst 505-b and SSB burst 505-d).

When and/or how the network entity triggers on-demand SSB transmission may be transparent to the UE. However, the UE may be informed when the UE is to expect on-demand SSB transmission from the cell. In some examples, both RRC and MAC-CE based signaling may be utilized for indications of on-demand SSB transmission on the cell supporting on-demand SSB Scell operations. For a cell supporting on-demand SSB SCell operation, a UE may support RRC based signaling to indicate on-demand SSB transmission on the cell at least for the case where this RRC also configures the SCell, activates the SCell, and provides on-demand SSB configuration. The system may support RRC based signaling for other cases as well. The system may support MAC-CE based signaling to indicate on-demand SSB transmissions on the cell for some scenarios (e.g., in which the SCell is configured to a UE but before the UE receives SCell activation command, or when the UE receives an SCell activation command). In some examples, deactivation and adaptation of on-demand SSB transmission may be supported. In some scenarios, the gNB may send the indication of OD-SSB transmission.

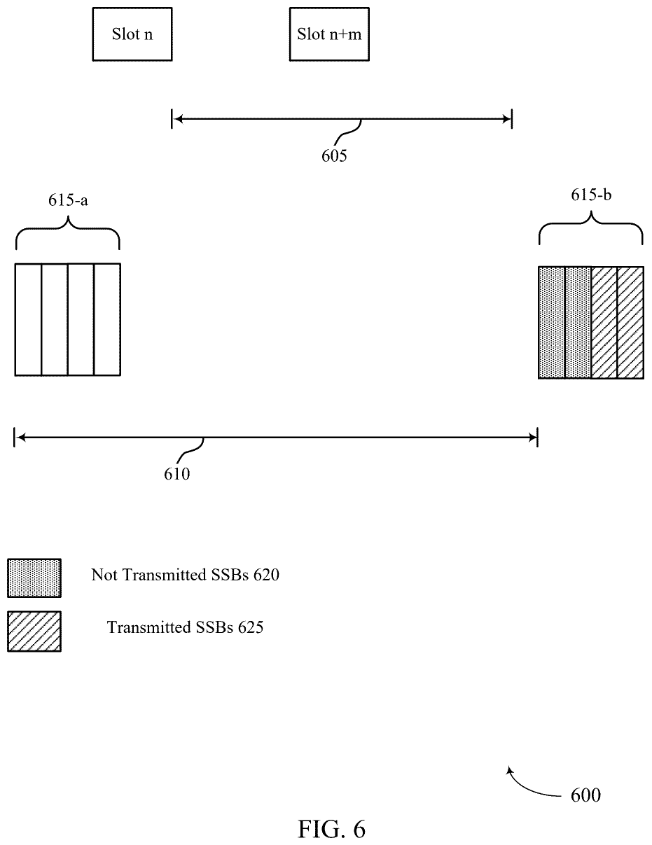

FIG. 6 shows an example of a timeline 600 that supports feature groups for on-demand operations in accordance with one or more aspects of the present disclosure. FIG. 6 may illustrate an example of a MAC-CE based timeline. Some wireless communications systems may support a MAC-CE based on-demand SSB indication. Such indications may be related to the MAC-CE based indication signaling to indicate on-demand SSB transmissions, as illustrated with reference to FIG. 6.

For SSB burst(s) indicated by on-demand SSB SCell operation via a MAC CE, the UE may expect that on-demand SSBs are transmitted from time instance A which is determined as follows: In some examples, instance A is the beginning of the first slot containing the first actually transmitted SSB index within the first possible (e.g., candidate) on-demand SSB burst which is at least T slots after the slot where the UE receives signaling from the network entity to indicate on-demand SSB transmission. The SSB time domain positions of on-demand SSB bursts may be configured by the network entity. The location(s) (e.g., SFN offset, half frame index) in the time domain of possible (e.g., candidate) on-demand SSB bursts and SSB positions within the burst may be configured by the network entity. In some examples, a value of T is not less than a threshold timeline for UE MAC CE processing for SCell activation. In some examples, T is not less than

$$T\_min = m + 3 {N}_{slot}^{s u bframe , μ} + 1$$

where slot n+m is a slot indicated for PUCCH transmission with HARQ-QCK information when the UE receives MAC CE signaling to indicate on-demand SSB transmission ending in slot n, and

$${N}_{slot}^{s u bframe , μ}$$

is as defined in one or more standards documents. In some examples, T_min may be equal to

$$m + 3 {N}_{slot}^{s u bframe , μ} + 1 ,$$

where T=T_min. Such techniques may apply at least for the case where an SCell with on demand SSB transmission and cell with signaling transmission have the same numerology.

For example, the offset 605 may represent

$$T = m + 3 {N}_{slot}^{s u bframe , μ} + 1.$$

a candidate SSB burst 615-a and a candidate SSB burst 615-b may occur according to a periodicity 610 (e.g., an SSB periodicity). The SSB burst 615-b may include no transmitted SSBs 620 and transmitted SSBs 625 (e.g., which occur after a time instance A in the SSB burst 615-b).

In some examples, a UE may support RRC-based on-demand SB transmission indications. The processing delay for RRC procedure may be defined, while the latency from UL grant to RRC UL response may be up to UE implementation. The UE may expect on-demand-SSB transmission from the first on-demand SSB burst after receiving RRC carrying an indication of on-demand-SSB transmission.

In some examples, the UE may support deactivation of on-demand SSB transmissions (e.g., for a cell supporting on-demand SSB SCell operations). For a cell supporting on-demand SSB SCell operation, deactivation of on-demand SSB transmission is supported. In order to deactivate on-demand SSB transmission from a UE perspective, the UE may support one or more options. For example, explicit deactivation indications may be used for on-demand SSBs via MAC-CE for on-demand SSB transmission indications, or deactivation may occur via RRC. In some examples, configuration or indications of a quantity N of on-demand SSB bursts 615 may be transmitted after on-demand SSBs are indicated.

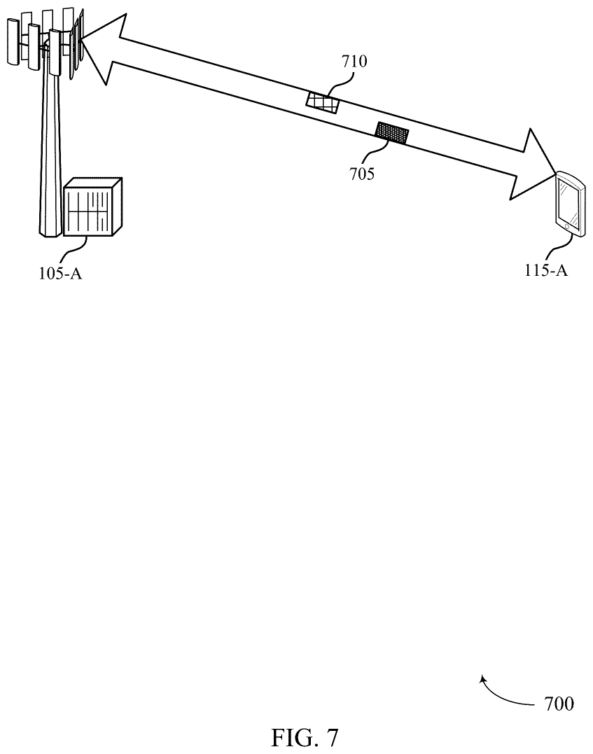

FIG. 7 shows an example of a wireless communications system 700 that supports feature groups for on-demand operations in accordance with one or more aspects of the present disclosure. The wireless communications system 700 may implement, or be implemented by, aspects of the wireless communications system 100, the timeline 200, the timeline 300, the timeline 400, the timeline 500, and the timeline 600. For example, the wireless communications system 700 may include a UE 115-a and a network entity 105-a, which may be examples of corresponding devices described with reference to FIGS. 1-6.

As described herein, the UE 115-a may transmit a capability information message (e.g., a message 705). The message may include an indication of a feature group (e.g., which may be referred to as an FG), and the feature group may indicate components supported by the UE. The feature groups may be defined in one or more standards documents, configured at the UE 115-a (e.g., via a lookup table indexed as illustrated below, or the like). Each feature group may correspond to one or more features supported by the UE, one or more components supported by the UE, one or more prerequisite feature groups also supported by the UE (e.g., to support the indicated features), and a signaling granularity.

A UE 115-a may support a MAC-CE based indication. For example, for a MAC-CE based indication of on-demand SSB transmissions, the following feature groups may be supported as described with reference to Table 1:

TABLE 1

| | | | | Prerequisite | Signaling |
|---|---|---|---|---|---|
| | Feature | | | feature | granularity |
| Index | group | Components | | groups | (*) |
| X-1 | MAC-CE | 1. | Support of on- | 6-5 and/or 6-6 | Per BC |
| | based | | demand SSB Scell | | |
| | indication | | operation for Scell | | |
| | and | | without always-on | | |
| | deactivation | | SSB transmission | | |
| | for Case #1 | 2. | Support of MAC- | | |
| | | | CE based indication | | |
| | | | of on-demand SSB | | |
| | | | transmission and | | |
| | | | support of MAC-CE | | |
| | | | based deactivation | | |
| | | | of on-demand SSB | | |
| | | | transmission | | |
| X-2 | MAC-CE | 1. | Support of on- | 6-5 and/or 6-6 | Per BC |
| | based | | demand SSB Scell | | |
| | indication | | operation for Scell | | |
| | and | | without always-on | | |
| | deactivation | | SSB transmission | | |
| | based on on- | 2. | Support of MAC- | | |
| | demand SSB | | CE based indication | | |
| | transmission | | of on-demand SSB | | |
| | duration for | | transmission and | | |
| | Case #1 | | support of on- | | |
| | | | demand SSB | | |
| | | | transmission | | |
| | | | deactivation based | | |
| | | | on a duration of on- | | |
| | | | demand SSB | | |
| | | | transmission | | |
| X-3 | MAC-CE | 1. | Support of on- | 6-5 and/or 6-6 | Per BC |
| | based | | demand SSB Scell | | |
| | indication | | operation for Scell | | |
| | and | | with always-on SSB | | |
| | deactivation | | transmission in | | |
| | for Case #2 | | which | | |
| | | | Always-on SSB | | |
| | | | and on-demand | | |
| | | | SSB are | | |
| | | | transmitted in | | |
| | | | the same center | | |
| | | | frequency | | |
| | | | The time | | |
| | | | domain | | |
| | | | locations of | | |
| | | | always-on SSB | | |
| | | | burst is a subset | | |
| | | | of the time | | |
| | | | domain | | |
| | | | locations of on- | | |
| | | | demand SSB | | |
| | | | burst. | | |
| | | | Support of | | |
| | | | MAC-CE based | | |
| | | | indication of | | |
| | | | on-demand SSB | | |
| | | | transmission | | |
| | | | and support of | | |
| | | | MAC-CE based | | |
| | | | deactivation of | | |
| | | | on-demand SSB | | |
| | | | transmission | | |
| X-4 | MAC-CE | 1. Support of on- | | 6-5 and/or 6-6 | Per BC |
| | based | demand SSB Scell | | | |
| | indication | operation for Scell with | | | |
| | and | always-on SSB | | | |
| | deactivation | transmission in which | | | |
| | based on on- | | Always-on SSB | | |
| | demand SSB | | and on-demand | | |
| | transmission | | SSB are | | |
| | duration for | | transmitted in | | |
| | Case #2 | | the same center | | |
| | | | frequency | | |
| | | | The time | | |
| | | | domain | | |
| | | | locations of | | |
| | | | always-on SSB | | |
| | | | burst is a subset | | |
| | | | of the time | | |
| | | | domain | | |
| | | | locations of on- | | |
| | | | demand SSB | | |
| | | | burst. | | |
| | | 2. Support of MAC-CE | | | |
| | | based indication of on- | | | |
| | | demand SSB | | | |
| | | transmission and on- | | | |
| | | demand SSB | | | |
| | | transmission | | | |
| | | deactivation based on | | | |
| | | duration of on-demand | | | |
| | | SSB transmission | | | |
| X-5 | MAC-CE | 1. | Support of on- | 6-5 and/or 6-6 | Per BC |
| | based on- | | demand SSB Scell | | |
| | demand SSB | | operation for Case 2 | | |
| | transmission | | in which always-on | | |
| | indication for | | SSB and on-demand | | |
| | Case #2 with | | SSB are transmitted | | |
| | different | | in the different | | |
| | center | | center frequencies | | |
| | frequencies | 2. | Support MAC-CE | | |
| | for always- | | based of on-demand | | |
| | on SSB and | | SSB transmission | | |
| | on-demand | | and support of | | |
| | SSB | | MAC-CE based | | |
| | | | deactivation of on- | | |
| | | | demand SSB | | |
| | | | transmission | | |
| X-6 | MAC-CE | 1. | Support of on- | 6-5 and/or 6-6 | Per BC |
| | based on- | | demand SSB Scell | | |
| | demand SSB | | operation for Case 2 | | |
| | transmission | | in which always-on | | |
| | indication for | | SSB and on-demand | | |
| | Case #2 with | | SSB are transmitted | | |
| | different | | in the different | | |
| | center | | center frequencies | | |
| | frequencies | 2. | Support MAC-CE | | |
| | for always- | | based indication of | | |
| | on SSB and | | on-demand SSB | | |
| | on-demand | | transmission and | | |
| | SSB | | support of on- | | |
| | | | demand SSB | | |
| | | | transmission | | |
| | | | deactivation based | | |
| | | | on duration of on- | | |
| | | | demand SSB | | |
| | | | transmission | | |

In general, feature group (FG) X-5/X-6 should be able to cover whether only one of the cases (e.g., always-on SSB and OD-SSB) or both always-on SSB and OD-SSB can be used for SSB based measurement/operation. However, additional FGs may be used for the UE 115-a to report whether it can support both always-on SSB and OD-SSB for SSB based measurement/operation when the SSBs are transmitted in different frequencies.

For a MAC-CE based indication of on-demand SSB transmission for Case 2 in which always-on SSB and on-demand SSB are transmitted in the different center frequencies, an additional feature group may be defined to report whether the UE 115-a can support that both always-on SSB and OD-SSB can be configured for SSB-based procedure/operation. Without reporting this FG, only either always-on SSB or OD-SSB can be configured for SSB-based procedure/operation. Such FGs are defined with reference to Table 2:

TABLE 2

| | | | Prerequisite | Signaling |
|---|---|---|---|---|
| | | | feature | granularity |
| Index | Feature group | Components | groups | (*) |

| | | | |
|---|---|---|---|
| X-7 | Support on-demand | 1. | Support of on-demand |
| | SSB Scell operation for | | SSB Scell operation |
| | Case #2 in which both | | Case #2 in which |
| | always-on SSB and | | always-on SSB and |
| | OD-SSB can be | | on-demand SSB are |
| | configured/used for | | transmitted in the |
| | SSB based | | different center |
| | measurement/operation. | | frequencies |
| | | 2. | Both always-on SSB |
| | | | and OD-SSB can be |
| | | | configured for SSB- |
| | | | based |
| | | | procedure/operation |

In some examples, one or more additional FGs may be reported, or may be prerequisite feature groups (e.g., as illustrated with reference to Table 3:

TABLE 3

| | | |
|---|---|---|
| 6-5 | Basic DL NR-NR | 1) Up to16 DL carriers |
| | CA operation | 2) Same numerology across carrier for |
| | | data/control channel at a given time |
| 6-6 | Basic UL NR-NR | 1) Up to16 UL carriers |
| | CA operation | 2) Same numerology across carrier for |
| | | data/control channel at a given time |
| | | 3) One PUCCH group |
| | | 4) Single TAG |

It is possible that feature group X-1 and feature group X-3 are merged into a feature group. Similarly, feature group X-2 and feature group X-4 may be merged into an FG. In this case, a limitation should be defined so that a mixture of cells with Case #1 and cells with Case #2 is not simultaneously configured in the CA configuration.

In some examples, for the case that feature group X-1 and feature group X-3 are merged into an feature group and feature group X-2 and feature group X-4 are merged into an FG, such FGs may be defined such that the UE 115-a is not expected to be configured with a set of cells with Case #1 and another set of cells with Case #2. While avoiding CA deployments without a mixture of cells with Case #1 and cells with Case #2 can simplify UE implementation, such limitation may reduce the flexibility at network side. Hence, it is reasonable to introduce additional feature group for UEs capable of supporting CA configuration with such mixture.

In some examples, for the case that feature group X-1 and feature group X-3 are merged into an feature group and feature group X-2 and feature group X-4 are merged into an FG, a separate feature group may be defined for the UE 115-a to report its capability to support CA configuration with a set of cells with Case #1 and another set of cells with Case #2, as illustrated with reference to Table 4:

TABLE 4

| | | | | |
|---|---|---|---|---|
| | | | Prerequisite | Signaling |
| | | | feature | granularity |
| Index | Feature group | Components | groups | (*) |

| | | |
|---|---|---|
| X-8 | Support on-demand | Support of on-demand SSB |
| | SSB Scell operation | Scell operation with CA |
| | with CA configuration | configuration having a set |
| | having a set of cells | of cells with Case #1 and |
| | with Case #1 and | another set of cells with |
| | another set of cells | Case #2. |
| | with Case #2. | |

In some examples, the UE 115-a may support RRC-based indications. For example, for RRC-based indication of on-demand SSB transmission, the following feature groups may be defined, as illustrated with reference to Table 5:

TABLE 5

| | | | | Prerequisite | Signaling | |
|---|---|---|---|---|---|---|
| | | | | feature | granularity | |
| Index | Feature group | Components | | groups | (*) | Note |
| X-9 | RRC based | RRC based indication and | | | | |
| | indication and | RRC based deactivation for | | | | |
| | RRC based | Scell without always-on SSB | | | | |
| | deactivation for | transmission. | | | | |
| | Case 1 | | | | | |
| X-10 | RRC based | 1. | Support of on-demand | [FG to | Per BC | Note: For |
| | indication and | | SSB Scell operation for | support | | a BC, the |
| | MAC-CE based | | Case #1 | RRC-based | | UE |
| | deactivation for | 2. | Support of RRC based | Scell | | reports |
| | Case #1 | | indication of on-demand | activation | | the |
| | | | SSB transmission and | R17] | | support |
| | | | support of MAC-CE | | | for each |
| | | | based deactivation of on- | | | frequency |
| | | | demand SSB transmission | | | range |
| | | | | | | associated |
| | | | | | | with one |
| | | | | | | or |
| | | | | | | multiple |
| | | | | | | Scells. |
| X-11 | RRC based | 1. | Support of on-demand | [FG to | Per BC | Note: For |
| | indication and | | SSB Scell operation for | support | | a BC, the |
| | deactivation | | Case #1 | RRC-based | | UE |
| | based on on- | 2. | Support of RRC based | Scell | | reports |
| | demand SSB | | indication of on-demand | activation] | | the |
| | transmission for | | SSB transmission and | | | support |
| | Case #1 | | support of on-demand | | | for each |
| | | | SSB transmission | | | frequency |
| | | | deactivation based on | | | range |
| | | | duration of on-demand | | | associated |
| | | | SSB transmission | | | with one |
| | | | | | | or |
| | | | | | | multiple |
| | | | | | | Scells. |

The ‘type’ definition from UE features should be based on the granularity of 1) Per UE or 2) Per Band or 3) Per BC or 4) Per FS or 5) Per FSPC). UE capability parameters have a hierarchical structure. In the table of UE capability parameter in subsequent clauses, “Per” indicates the level the associated parameter is included. “UE” in the column indicates the associated parameter is signaled per UE, “Band” indicates it is signaled per band, “BC” indicates it is signaled per band combination, “FS” indicates it is signaled per feature set (per band per band combination), “FSPC” indicates it is signaled per feature set per component carrier (per CC per band per band combination), and “FD” in the column indicates to refer the associated field description.

As illustrated with reference to tables 1-5, signaling granularity may be “per BC”. However, the signaling granularity may also be defined as per UE, per FSPC, per CC per band per band combination, per frequency range or per carrier type (FR1 TDD, FR1 FDD, FR1 unlicensed, FR2, etc.), where carrier type is defined with respect to target SCell where OD-SSB can be configured/activated.

In some examples, the UE 115-a may support (e.g., and may indicate via a feature group), that it supports L3 measurements based on on-demand SSBs. For the Scell, it is clear to UE 115-a on when/where the on-demand SSB is transmitted because of the indication from the gNB (RRC or/and MAC-CE). However, for a neighbor cell which is not the Scell, the gNB does not provide any information on whether the cell support on-demand SSB or not. Even though the network can inform the UE that the cell supports on-demand SSB operation, when/where on-demand SSB is transmitted in the cell is also unknown to the UE. Therefore, to leverage the UE implementation while ensuring RRM measurement accuracy, for L3 measurement of neighbor cells based on SSB, UE assumes one or more of the following: the neighbor cells other than the configured Scell(s) do not support on-demand SSB; if the neighbor cells other than the configured Scell can support on-demand SSB, the neighbor cells can support on-demand SSB Case #2 only. In this case, the always-on SSB can be used for neighboring cell measurement. This also generates a network deployment with a mixture of Case #1 in Scell while Case #2 in other neighbor cells. Such assumptions may be the basis for the feature groups. In some cases, the system may support a deployment in which the neighbor cells may support Case #1 or the SSB configured for L3 measurement from neighbor cells is on-demand SSB in Case #2. In this situation, the system may define separate UE capabilities to indicate such support

In some examples, one or more FGs may be defined to report whether the UE 115-a can support L3 measurement for deployment in which neighbor cells have Case #1 or the deployment in which OD-SSB in Case #2 can be configured for L3 measurement of neighbor cell, as described with reference to table 6:

TABLE 6

| | | | | |
|---|---|---|---|---|
| | | | Prerequisite | Signaling |
| | | | feature | granularity |
| Index | Feature group | Components | groups | (*) |

| | | |
|---|---|---|
| X-12 | Support L3 | Support of L3 measurement in |
| | measurement in | which neighbor cells have |
| | which neighbor cells | Case #1 or OD-SSB in Case #2 |
| | have Case #1 or OD- | can be configured for neighbor |
| | SSB in Case #2 can | cell's L3 measurement |
| | be configured for | |
| | neighbor cell's L3 | |
| | measurement | |

The UE 115-a may transmit the message 705 indicating capability information. For example, the UE 115-a may transmit a capability information message including an index value (e.g., one of X-1 through X-12, or any of the combined FGs described herein, among other examples). The capability information message may indicate one or more of a supported feature group and one or more components corresponding to the feature group, one or more prerequisite feature groups (e.g., if any) supported by the UE 115-a, a signaling granularity for the supported features, or any combination thereof. In some examples, the feature group may be indicated based on an explicit index value included in the message 705, resources via which the message is transmitted, a timing or encoding of the message, or the like. In some examples, the UE 115-a may receive (e.g., from the network entity 105-a) one or more downlink signals 710 (e.g. on-demand or periodic SSBs, or a MAC-CE or RRC message activating or deactivating the SSBs, among other examples) based at least in part on having transmitted the capability information. In some examples, one or more lookup tables may be configured indicating the various indices for the feature groups and corresponding information (e.g., as illustrated with reference to tables 1-6).

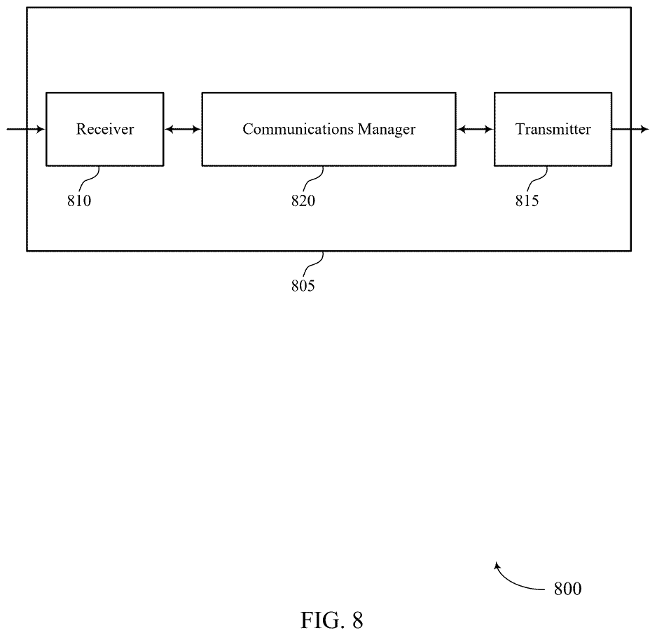

FIG. 8 shows a block diagram 800 of a device 805 that supports feature groups for on-demand operations in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to feature groups for on-demand operations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to feature groups for on-demand operations). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of feature groups for on-demand operations as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof. The communications manager 820 is capable of, configured to, or operable to support a means for receiving a control message activating or deactivating on-demand SSB transmissions for the cell based at least in part on the capability information message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for capability reporting resulting in reduced processing, reduced power consumption, more efficient utilization of communication resources, and improved user experience.

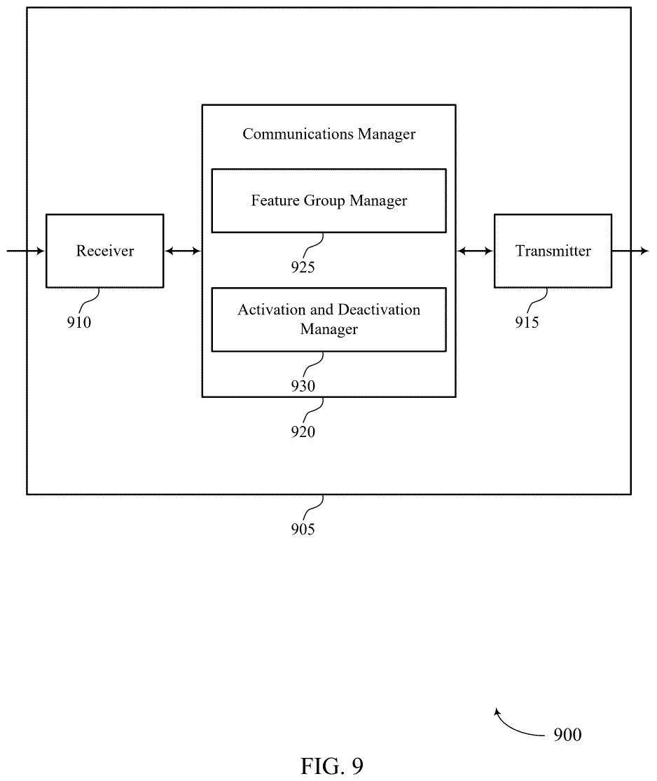

FIG. 9 shows a block diagram 900 of a device 905 that supports feature groups for on-demand operations in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to feature groups for on-demand operations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to feature groups for on-demand operations). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of feature groups for on-demand operations as described herein. For example, the communications manager 920 may include a feature group manager 925 an activation and deactivation manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The feature group manager 925 is capable of, configured to, or operable to support a means for a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof. The activation and deactivation manager 930 is capable of, configured to, or operable to support a means for receiving a control message activating or deactivating on-demand SSB transmissions for the cell based at least in part on the capability information message.

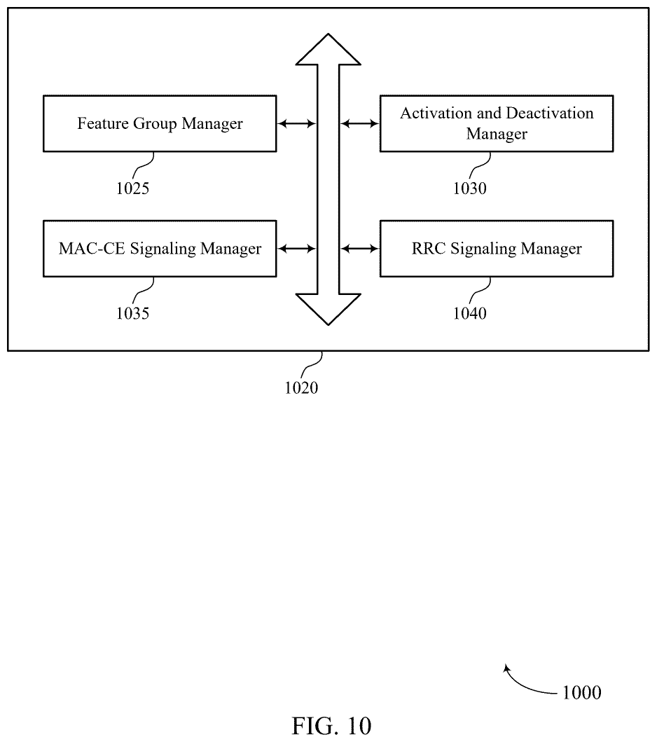

FIG. 10 shows a block diagram 1000 of a communications manager 1020 that supports feature groups for on-demand operations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of feature groups for on-demand operations as described herein. For example, the communications manager 1020 may include a feature group manager 1025, an activation and deactivation manager 1030, a MAC-CE signaling manager 1035, an RRC signaling manager 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The feature group manager 1025 is capable of, configured to, or operable to support a means for transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof. The activation and deactivation manager 1030 is capable of, configured to, or operable to support a means for receiving a control message activating or deactivating on-demand SSB transmissions for the cell based at least in part on the capability information message.

In some examples, to support receiving the control message, the MAC-CE signaling manager 1035 is capable of, configured to, or operable to support a means for receiving a MAC control element (CE), where the supported feature group includes an indication that the UE supports the activation or deactivation via the MAC-CE.

In some examples, to support receiving the control message, the RRC signaling manager 1040 is capable of, configured to, or operable to support a means for receiving an RRC message, where the supported feature group includes an indication that the UE supports the activation or deactivation via the RRC message.

In some examples, the supported feature group includes an indication that the UE supports activation or deactivation of the on-demand SSB transmissions, and the feature group support is applied to a single set of one or more cells with periodic SSB transmissions or is applied to single set of one or more cells without periodic SSB transmissions.

In some examples, the supported feature group includes an indication that the UE supports carrier aggregation, and that the UE supports activation or deactivation of on-demand SSB transmissions in addition to the periodic SSB transmissions via a first set of one or more cells, and supports activation or deactivation of the on-demand SSB transmissions via a second set of one or more cells without periodic SSB transmissions that is different from the first set of one or more cells.

In some examples, the signaling granularity level includes a per device granularity, a per band granularity, a per band combination granularity, a feature set per component carrier granularity, a per frequency range granularity, a per carrier type granularity, a per component carrier per band per band combination, or any combination thereof.

In some examples, the supported feature group includes an indication that the UE supports layer three measurements for deployment where one or more neighbor cells support the periodic SSB transmissions or the on-demand SSB transmissions.

In some examples, the supported feature group corresponds to one or more prerequisite feature groups that are also supported by the UE.

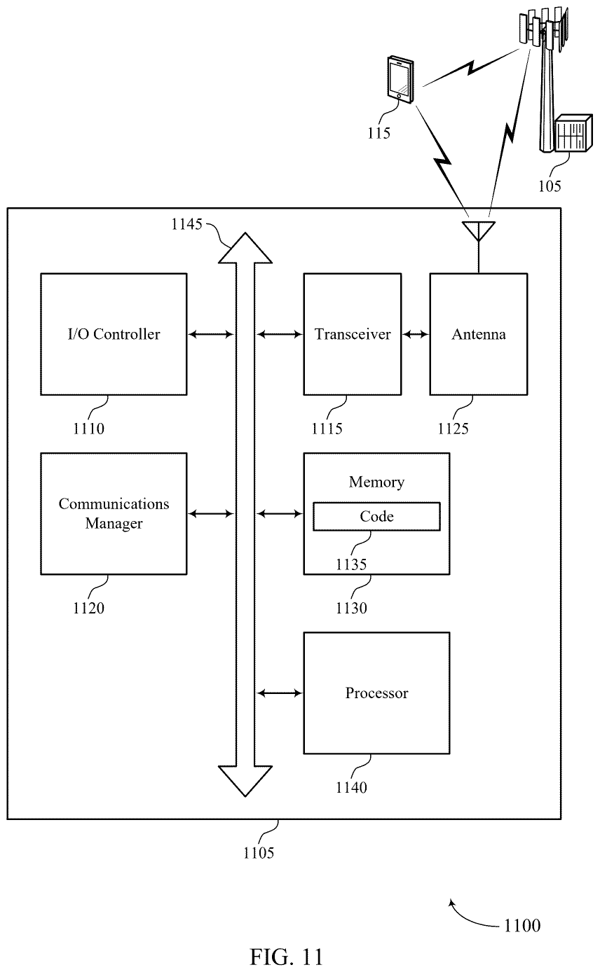

FIG. 11 shows a diagram of a system 1100 including a device 1105 that supports feature groups for on-demand operations in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting feature groups for on-demand operations). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof. The communications manager 1120 is capable of, configured to, or operable to support a means for receiving a control message activating or deactivating on-demand SSB transmissions for the cell based at least in part on the capability information message.

By including or configuring the communications manager 1120 in accordance with examples as described herein, the device 1105 may support techniques for capability reporting resulting in reduced processing, reduced power consumption, more efficient utilization of communication resources, improved communication reliability, reduced latency, improved user experience related to reduced processing, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of feature groups for on-demand operations as described herein, or the at least one processor 1140 and the at least one memory 1130 may be otherwise configured to, individually or collectively, perform or support such operations.

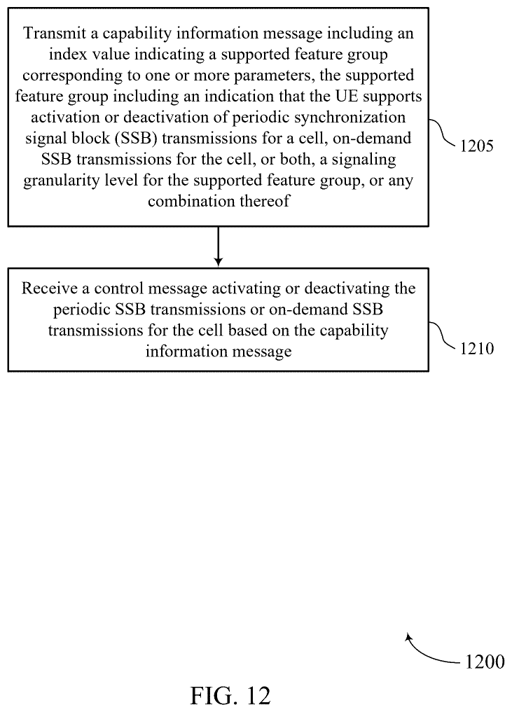

FIG. 12 shows a flowchart illustrating a method 1200 that supports feature groups for on-demand operations in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include transmitting a capability information message including an index value indicating a supported feature group corresponding to one or more parameters, the supported feature group including an indication that the UE supports a cell having on-demand SSB transmissions only, or having both periodic synchronization signal block (SSB) transmissions and on-demand SSB transmissions, a signaling granularity level for the supported feature group, or any combination thereof. The operations of 1205 may be performed in accordance with examples as disclosed herein. In some examples, aspects of the operations of 1205 may be performed by a feature group manager 1025 as described with reference to FIG. 10.

At 1210, the method may include receiving a control message activating or deactivating on-demand SSB transmissions for the cell based at least in part on the capability information message. The operations of 1210 may be performed in accordance with examples as disclosed herein. In some examples, aspects of the operations of 1210 may be performed by an activation and deactivation manager 1030 as described with reference to FIG. 10.

The following provides an overview of aspects of the present disclosure:

Aspect 1: A method for wireless communications at a UE, comprising: transmitting a capability information message comprising an index value indicating a supported feature group corresponding to one or more parameters, the supported feature group comprising an indication that the UE supports a cell having on-demand SSB transmissions only, or having both periodic synchronization signal block (SSB) transmissions and on-demand SSB transmissions, a signaling granularity level for the supported feature group, or any combination thereof; and receiving a control message activating or deactivating on-demand SSB transmissions for the cell based at least in part on the capability information message.

Aspect 2: The method of aspect 1, wherein receiving the control message comprises: receiving a MAC control element (CE), wherein the supported feature group comprises an indication that the UE supports the activation or deactivation via the MAC-CE.

Aspect 3: The method of any of aspects 1 through 2, wherein receiving the control message comprises: receiving an RRC message, wherein the supported feature group comprises an indication that the UE supports the activation or deactivation via the RRC message.

Aspect 4: The method of any of aspects 1 through 3, wherein the supported feature group comprises an indication that the UE supports activation or deactivation of the on-demand SSB transmissions, and the feature group support is applied to a single set of one or more cells with periodic SSB transmissions or is applied to single set of one or more cells without periodic SSB transmissions.

Aspect 5: The method of any of aspects 1 through 4, wherein the supported feature group comprises an indication that the UE supports carrier aggregation, and that the UE supports activation or deactivation of on-demand SSB transmissions in addition to the periodic SSB transmissions via a first set of one or more cells, and supports activation or deactivation of the on-demand SSB transmissions via a second set of one or more cells without periodic SSB transmissions that is different from the first set of one or more cells.

Aspect 6: The method of any of aspects 1 through 5, wherein the signaling granularity level comprises a per device granularity, a per band granularity, a per band combination granularity, a feature set per component carrier granularity, a per frequency range granularity, a per carrier type granularity, a per component carrier per band per band combination, or any combination thereof.

Aspect 7: The method of any of aspects 1 through 6, wherein the supported feature group comprises an indication that the UE supports layer three measurements for deployment where one or more neighbor cells support the periodic SSB transmissions or the on-demand SSB transmissions.

Aspect 8: The method of any of aspects 1 through 7, wherein the supported feature group corresponds to one or more prerequisite feature groups that are also supported by the UE.

Aspect 9: A UE for wireless communications, comprising one or more memories storing processor-executable code, and one or more processors coupled with the one or more memories and individually or collectively operable to execute the code to cause the UE to perform a method of any of aspects 1 through 8.

Aspect 10: A UE for wireless communications, comprising at least one means for performing a method of any of aspects 1 through 8.

Aspect 11: A non-transitory computer-readable medium storing code for wireless communications, the code comprising instructions executable by one or more processors to perform a method of any of aspects 1 through 8.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability information message comprising an index value indicating a supported feature group corresponding to one or more parameters, the supported feature group comprising an indication that the UE supports a cell having on-demand SSB transmissions only, or having both periodic synchronization signal block (SSB) transmissions and on-demand SSB transmissions, a signaling granularity level for the supported feature group, or any combination thereof; and
receive a control message activating or deactivating on-demand SSB transmissions for the cell in accordance with the supported feature group.

2. The UE of claim 1, wherein, to receive the control message, the one or more processors are individually or collectively operable to execute the code to cause the UE to:
receive a media access control (MAC) control element (CE), wherein the supported feature group comprises an indication that the UE supports the activation or deactivation via the MAC-CE.

3. The UE of claim 1, wherein, to receive the control message, the one or more processors are individually or collectively operable to execute the code to cause the UE to:
receive a radio resource control (RRC) message, wherein the supported feature group comprises an indication that the UE supports the activation or deactivation via the RRC message.

4. The UE of claim 1, wherein the capability information message an indication that the UE supports activation or deactivation of the on-demand SSB transmissions, and the feature group support is applied to a single set of one or more cells with periodic SSB transmissions or is applied to single set of one or more cells without periodic SSB transmissions.

5. The UE of claim 1, wherein the capability information message comprises an indication that the UE supports carrier aggregation, and that the UE supports activation or deactivation of on-demand SSB transmissions in addition to the periodic SSB transmissions via a first set of one or more cells, and supports activation or deactivation of the on-demand SSB transmissions via a second set of one or more cells without periodic SSB transmissions that is different from the first set of one or more cells.

6. The UE of claim 1, wherein the signaling granularity level comprises a per device granularity, a per band granularity, a per band combination granularity, a feature set per component carrier granularity, a per frequency range granularity, a per carrier type granularity, a per component carrier per band per band combination, or any combination thereof.

7. The UE of claim 1, wherein the capability information message comprises an indication that the UE supports layer three measurements for deployment where one or more neighbor cells support the periodic SSB transmissions or the on-demand SSB transmissions.

8. The UE of claim 1, wherein the supported feature group corresponds to one or more prerequisite feature groups that are also supported by the UE.

9. A method for wireless communications at a user equipment (UE), comprising:
transmitting a capability information message comprising an index value indicating a supported feature group corresponding to one or more parameters, the supported feature group comprising an indication that the UE supports a cell having on-demand SSB transmissions only, or having both periodic synchronization signal block (SSB) transmissions and on-demand SSB transmissions, a signaling granularity level for the supported feature group, or any combination thereof; and
receiving a control message activating or deactivating on-demand SSB transmissions for the cell in accordance with the supported feature group.

10. The method of claim 9, wherein receiving the control message comprises:
receiving a media access control (MAC) control element (CE), wherein the supported feature group comprises an indication that the UE supports the activation or deactivation via the MAC-CE.

11. The method of claim 9, wherein receiving the control message comprises:
receiving a radio resource control (RRC) message, wherein the supported feature group comprises an indication that the UE supports the activation or deactivation via the RRC message.

12. The method of claim 9, wherein the capability information message comprises an indication that the UE supports activation or deactivation of the on-demand SSB transmissions, and the feature group support is applied to a single set of one or more cells with periodic SSB transmissions or is applied to single set of one or more cells without periodic SSB transmissions.

13. The method of claim 9, wherein the capability information message comprises an indication that the UE supports carrier aggregation, and that the UE supports activation or deactivation of on-demand SSB transmissions in addition to the periodic SSB transmissions via a first set of one or more cells, and supports activation or deactivation of the on-demand SSB transmissions via a second set of one or more cells without periodic SSB transmissions that is different from the first set of one or more cells.

14. The method of claim 9, wherein the signaling granularity level comprises a per device granularity, a per band combination granularity, a feature set per component carrier granularity, a per frequency range granularity, a per carrier type granularity, a per component carrier per band per band combination, or any combination thereof.

15. The method of claim 9, wherein the capability information message comprises an indication that the UE supports layer three measurements for deployment where one or more neighbor cells support the periodic SSB transmissions or the on-demand SSB transmissions.

16. The method of claim 9, wherein the supported feature group corresponds to one or more prerequisite feature groups that are also supported by the UE.

17. A non-transitory computer-readable medium storing code for wireless communications, the code comprising instructions executable by one or more processors to:
transmit a capability information message comprising an index value indicating a supported feature group corresponding to one or more parameters, the supported feature group comprising an indication that a user equipment (UE) supports a cell having on-demand SSB transmissions only, or having both periodic synchronization signal block (SSB) transmissions and on-demand SSB transmissions, a signaling granularity level for the supported feature group, or any combination thereof, and
receive a control message activating or deactivating on-demand SSB transmissions for the cell in accordance with the supported feature group.

18. The non-transitory computer-readable medium of claim 17, wherein the instructions to receive the control message are executable by the one or more processors to:
receive a media access control (MAC) control element (CE), wherein the supported feature group comprises an indication that the UE supports the activation or deactivation via the MAC-CE.

19. The non-transitory computer-readable medium of claim 17, wherein the instructions to receive the control message are executable by the one or more processors to:
receive a radio resource control (RRC) message, wherein the supported feature group comprises an indication that the UE supports the activation or deactivation via the RRC message.

20. The non-transitory computer-readable medium of claim 17, wherein the capability information message comprises an indication that the UE supports activation or deactivation of the on-demand SSB transmissions, and the feature group support is applied to a single set of one or more cells with periodic SSB transmissions or is applied to single set of one or more cells without periodic SSB transmissions.
